(19) United States
(12) Patent Application Publication
(10) Pub. No.: US 2004/0163958 A1
(43) Pub. Date: Aug. 26, 2004

(54) Straightflow system

(76) Inventors: Hung Pin Kao, Fremont, CA (US); Kevin Maher, Woodside, CA (US)

Correspondence Address: ACLARA BIOSCIENCES, INC., 1288 PEAR AVENUE, MOUNTAIN VIEW, CA, 94043, US

(21) Appl. No.: 10/757,666

(22) Filed: Jan. 14, 2004

Related U.S. Application Data
(63) Continuation of application No. PCT/US02/24663, filed on Aug. 2, 2002.
(60) Provisional application No. 60/310,065, filed on Aug. 3, 2001.

(30) Foreign Application Priority Data
Aug. 2, 2002 (WO) PCT/US02/24663

(51) Int. Cl. G01N 27/453

(52) U.S. Cl. 204/450; 204/600

(57) ABSTRACT

A microfabricated device for electrokinetically moving biological and chemical samples includes a detection chamber for receiving a plurality of adjacent sample streams to be detected. The device includes a plurality of adjacent input channels fluidly connected to the detection chamber and each of the input channels is fluidly connected to the detection chamber via an enlarged end section. The enlarged end section may be an expanding taper having its widest end at the detection chamber. The taper may further be linear or parabolic shaped, or the taper may have other shapes. The novel enlarged end section provides for the plurality of adjacent sample streams to enter the detection chamber and remain substantially discrete for at least a threshold distance through the detection chamber. Accordingly, lateral diffusion of the samples is minimized. The microfabricated device may also feature a plurality of tapered junctions each of which is interposed between adjacent input channels. Channel supports may also be disposed in the detection chamber and opposite of the tapered junctions to further control flow of the samples. A method for multiplexed detection of samples in a microfluidic device comprises the steps of electrokinetically flowing at least two sample streams into a detection chamber wherein the at least two sample streams define a device plane. A light beam is directed through the detection chamber such that the light beam perpendicularly intersects the at least two sample streams and propagates in the device plane. The method may include flowing ancillary flows around the sample streams such that lateral dispersion is prevented. Systems and manifolds are provided which have improved detection chamber designs.

### CROSS-REFERENCE TO RELATED APPLICATIONS AND PATENTS

This application claims priority to International application PCT/US02/24663 filed 02 Aug. 2002 and U.S. provisional applications Ser. No. 60/310,065 filed 03 Aug. 2001, which applications are incorporated herein by reference in its entirety

### TECHNICAL FIELD

This invention relates to microfabricated devices for performing various biological and chemical analyses.

### BACKGROUND

Various biological and chemical analyses include: DNA sequencing, RNA analysis, protein molecular weight determination, genetic mapping, drug screening, clinical diagnostics, etc. These analyses typically employ electrophoresis which may be carried out in a number of different formats.

Capillary electrophoresis (CE), for example, applies an electric field across a capillary tube having a small internal diameter to separate the samples into component species. Because CE dissipates heat more effectively than traditional slab-based electrophoresis, relatively higher electrical fields may be employed resulting in fast separations with minimal sample diffusion.

In traditional CE systems, detection is performed during electrophoresis while the sample is still located inside the capillary lumen. Excitation light required to excite the sample and emission light coming from the sample must therefore be transmitted through the walls of the capillary.

A drawback of this approach is that the fused silica capillaries typically used in CE are poor optical elements. That is, the capillaries cause significant scattering of light. Problems associated with light scattering are particularly problematic when it is desired to detect fluorescence from samples located in a plurality of closely-spaced capillaries by fluorescence because the scattered excitation light form one capillary will interfere with the detection of samples in neighboring capillaries.

To address light interference caused by neighboring capillaries, CE systems have been developed with open detection cells. An example of a CE system 100 having an “open” detection cell 120 is shown in FIG. 1A. The CE system 100 includes a plurality of capillaries 110 fluidly connected to a detection cell 120. The detection cell has desirable optical characteristics and may be, for example, a quartz chamber.

As shown in FIG. 1B, samples flow from the plurality of capillaries into the detection cell 120. The samples do not diffuse substantially because a “sheath flow” liquid surrounds the sample streams 130 as they flow through the detection cell 120. Detection is carried out by propagating an excitation beam 135 through the individual sample streams without contacting the capillaries 110.

A drawback of these sheathflow-based CE systems is that in order to avoid distortion of a sample zone in the detection cell, precise control of the flow rate of the sheath flow liquid is required. References describing CE systems employing sheath flow liquids include: U.S. Pat. Nos. 5,439,578 and 5,529,679 and H. Kambara and S. Takahashi, Multiple-sheathflow capillary array DNA analyzer Nature, v 361, 565 (1993).

Another CE design is described in U.S. Pat. No. 5,833,826 to Nordman (“the '826 patent”). In the '826 patent, a CE system includes a means for reducing the distortion of a sample zone eluting from a CE separation capillary. The '826 patent states: “one or more focusing electrodes [are] in electrical communication with the outlet ends of the separation capillaries [and] the voltage of each of the electrodes is adjusted such that (i) the sample zone is transported from the inlet end to the outlet end of the separation capillaries and (ii) the distortion of the sample zone eluting from the separation capillaries is reduced.” See Abstract.

Despite the above noted CE systems, CE systems remain undesirably complex, tedious, expensive, involve large sophisticated equipment and require relatively large sample and reagent volumes. For these reasons, improved approaches are still needed.

Microfluidic devices provide an alternative to CE systems. Microfluidic devices are microfabricated structures and are well suited for many applications including, for example, RNA/DNA analysis and high-throughput pharmaceutical drug screening. Microfabricated structures allow for small volumes (e.g., pico or nanoliter size volumes) of fluids to be electrokinetically transported through interconnected channel networks and enable a range of common laboratory procedures including: mixing, incubation, metering, dilution, purification, capture, concentration, injection, separation, and detection to be performed on a single chip. These microfabricated structures allow researchers to rapidly (and in parallel) perform large numbers of bio/chemical measurements in a format that is inexpensive, miniaturized, automated, and fast.

Microfluidic devices also support sensitive detection techniques such as, for example, Laser-induced fluorescence (LIF). LIF is used to detect compounds in microfabricated devices having channels for separation of the compounds. Typically, epi-fluorescence confocal microscopy is used for LIF where a laser beam is introduced normal to the top surface of the chip. FIG. 2 illustrates a typical setup wherein a laser beam 150 is directed normal to the plane of the microfabricated device 160.

Illumination of the detection zone from the top, however, is not practical for a number of reasons. First, light delivered from the top tends to excite and reflect off the substrate thereby increasing background. Autofluorescence caused by a light source encountering the substrate materials (i.e. plastic(s)) that comprise the microchannel walls aggravates problems encountered with LIF detection. An example of such is crosstalk between adjacent detection streams or plugs. This results in inaccurate or highly insensitive readings. Second, light delivered from the top requires that each channel have an individual laser beam. In order to collect signal from multiple channels, multiple laser beams must be employed. Use of multiple laser beams is undesirable due to the additional complexity of the optical system.

An example of a microfluidic device detection setup is described in U.S. Pat. No. 6,120,666 to Jacobson and S. C. Jacobson and J. M. Ramsey, Electrokinetic Focusing in Microfabricated Channel Structures, Anal. Chem., 69, p.3212 (1997). In particular, a means for focusing (or narrowing) streams in a focusing chamber is described. “By incorporation of transverse spatial confinement of the sample, the probe volume of the detector can be reduced and isolated from the container walls permitting more sensitive measurements to be made.” Id. at 3212. This conventional detection setup, however, directs light at the samples through the cover substrate and normal to the base substrate. Sensitivity is reduced to the extent the cover and base substrates interfere with an excitation light beam.

There is a continuing need for a microfabricated device and system that does not suffer from the above mentioned drawbacks.

There is also a continuing need for a microfabricated device and system having an improved design to enhance sample detection without the use of sheath flow fluids.

### SUMMARY OF THE INVENTION

In one variation of the present invention, a microfabricated device for electrokinetically moving samples is provided. The microfabricated device comprises a detection chamber for receiving a plurality of adjacent sample streams to be detected; a plurality of adjacent input channels fluidly connected to the detection chamber, each of the plurality of input channels fluidly connected to the detection chamber via an enlarged end section; and at least one output channel fluidly connected to the detection chamber such that when the plurality of adjacent sample streams enter the detection chamber the streams remain discrete for at least a threshold distance through the detection chamber. Consequently, sample detection is enhanced because lateral diffusion and mixing is minimized across the threshold distance while the samples migrate through the detection zone.

In one variation of the present invention, the end section varies in width as function of distance from the detection chamber and the end section is widest at the detection chamber. Preferably, the enlarged end section has a gradual taper. The taper may also be linear or parabolic.

The device of the present invention also features a plurality of tapered ends or junctions interposed between the input channels such that one tapered junction separates the end sections of adjacent input channels.

In another variation of the present invention, the detection chamber comprises a plurality of adjacent channel supports. The channel supports are positioned opposite the tapered junctions and useful in minimizing dispersion of electrical fields when electrical fields are applied to the device to electrokinetically move sample materials. The channel supports are also useful in preventing bowing of the cover across the detection chamber.

In another variation of the present invention, only one Y-shaped output channel is connected to the detection chamber. In another variation of the present invention, a plurality of output channels are connected to the detection chamber and output channels are positioned opposite of the input channels. The output channels may be configured as mirror images of the input channels.

In another variation of the present invention, a microfabricated manifold for use in electrokinetic applications is provided. The novel manifold comprises a detection chamber; a plurality of adjacent channel inlets fluidly connected to the detection chamber; and a tapered junction between adjacent channel inlets. In an aspect of the present invention, each channel inlet further comprises a first end and a second wider end downstream of the first end and the channel inlets are taper-shaped. The taper may also be linear or parabolic.

The microfabricated manifold of the present invention may also include at least one Y-shaped outlet. Alternatively, the manifold may comprise a channel outlet positioned opposite of each of the channel inlets.

In another variation of the present invention, the microfabricated manifold comprises a plurality of channel supports in the detection chamber. The channel supports are positioned opposite to the tapered junctions such that a sample stream exiting the channel inlet flows between two channel supports and minimizes diffusion in the lateral direction.

In another variation of the present invention, a method for multiplexed detection of samples in a microfluidic device is provided. The method comprises the steps of introducing a sample into at least two of the plurality of input channels of the device of any one of the above described variations; applying electrical fields to the device such that the samples flow as discrete sample streams from the plurality of input channels into the detection chamber; and detecting a property of the sample streams while the sample streams flow through the detection chamber.

Another variation of the present invention is a method for multiplexed detection of samples in a microfluidic device and comprises the steps of electrokinetically flowing at least two sample streams into a detection chamber wherein the at least two sample streams define a device plane. The method further comprises directing a light beam (such as a laser) through the detection chamber such that the light beam perpendicularly intersects the at least two sample streams and propagates in the device plane. The method further includes the step of detecting an optical property of the at least two sample streams as the streams flow through the detection chamber.

In a variation of the method of the present invention, the device comprises tapered junctions extending into the detection chamber and useful in preventing said sample streams from laterally dispersing.

The method of the present invention also includes providing sample streams that remain straight as the sample streams flow through the detection chamber. The method of the present invention may also provide organized sample streams that curve through the detection chamber and have minimal diffusion.

The method of the present invention may further comprise electrokinetically flowing ancillary flows around the sample streams such that lateral dispersion is prevented.

The method of the present invention may also include a reflector for reflecting the light beam through the detection chamber. The reflector may be formed on an outer or side channel and at a 45 degree angle to reflect a light beam from a first direction across the detection chamber in the plane of the device. In this variation, the light source can be normal to the plane of the device or at another angle to the plane of the device. In another variation of the present invention, the light beam is directed from a light source in the plane of the device.

In yet another variation of the present invention, a microfluidic system for carrying out various chemical and biochemical processes is provided. The system comprises a microfabricated device having a detection chamber and a plurality of input channels. The input channels define a plane of the device. The system further includes a controller adapted to provide electric fields to the device such that when samples are present in the input channels, the samples can be electrokinetically manipulated through the input channels and into the detection chamber by application of the electric fields. The system further includes a light beam directed across the detection chamber and in the plane of the device. The beam perpendicularly intersects the samples as the samples flow through the detection chamber. The system further includes at least one detector for measuring optical properties of the samples in the detection chamber wherein sample streams introduced into the detection chamber are illuminated and detected in parallel. The system of the present invention may also comprise a microfabricated device as described in the above variations.

Additionally, the system of the present invention may comprise ancillary flow channels interposed between the input channels such that confining streams from the ancillary flow channels confine sample streams entering the detection chamber. Consequently, diffusion of the sample streams is minimized.

Other features and advantages of the invention will be apparent from the following detailed description and the appended claims.

### BRIEF DESCRIPTION OF THE DRAWINGS

FIG. 1A is an illustration of a capillary electrophoresis system employing sheath flow liquids.

FIG. 1B is an expanded view of the detection region of the capillary electrophoresis system shown in FIG. 1A.

FIG. 2 is an illustration of a microfluidic system including a microfluidic device, a detector, and a laser beam directed normal to the plane of the microfluidic device.

FIG. 3A is a top view of a microfluidic device having a plurality of channels and a detection chamber in accordance with the present invention.

FIG. 3B is a perspective view of reservoir and channels in accordance with the present invention.

FIG. 4 is an illustration of a device fabrication process in accordance with the present invention.

FIG. 5 is a top view of a portion of a device in accordance with the present invention.

FIG. 6 is a top view of a detection chamber having a plurality of tapered junctions in accordance with the present invention.

FIG. 7 is a top view of another detection chamber having a plurality of tapered junctions in accordance with the present invention.

FIG. 8 is an illustration of a microfluidic device in accordance with the present invention in an application.

FIG. 9 is a top view of a portion of another device in accordance with the present invention.

FIG. 10 is an enlarged top view of a portion of the device shown in FIG. 9.

FIGS. 11A and 11B are illustrations of static electric field patterns and streamline trajectories for a massless particle released at the indicated line respectively in a microfabricated device in accordance with the present invention.

FIGS. 12A and 12B are illustrations of static electric field patterns and streamline trajectories for a massless particle released at the indicated line respectively in a microfabricated structure without means for confining sample streams.

FIG. 13 is a top view of a portion of another variation of the present invention having a plurality of channel supports.

FIGS. 14A and 14B are illustrations of static electric field patterns and streamline trajectories for a massless particle released at the indicated line respectively in the microfabricated device shown in FIG. 13.

FIG. 15 is a top view of a portion of another variation of the present invention.

FIG. 16A is an illustration of a detection setup in accordance with present invention.

FIG. 16B is a cross-sectional view of a detection chamber in accordance with the present invention depicting a laser beam propagating across a plurality of parallel sample streams in the plane of the device.

FIG. 17 is a cross-sectional view of a portion of a device in accordance with the present invention depicting a laser beam propagating across a plurality of sample channels.

FIG. 18 is a cross-sectional view of a portion of a device in accordance with the present invention depicting a laser beam propagating across a channel having a draft angel.

FIG. 19 is a schematic illustration of a light beam directed at a channel having a draft angle.

FIG. 20A is a graph showing entry angle for a given draft angle.

FIG. 20B is a graph showing vertical deviation for a given entry angle and propagation distance.

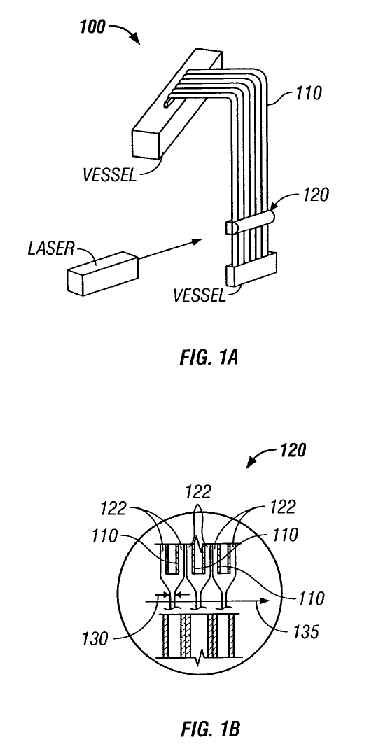

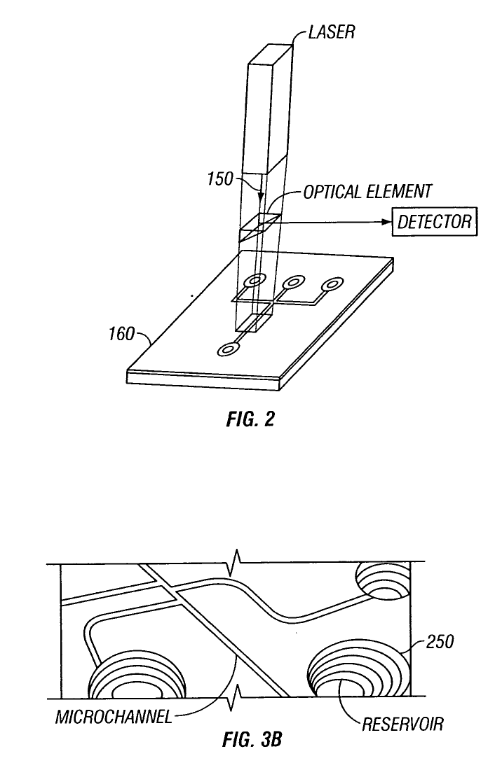

### DETAILED DESCRIPTION

The present invention is a microfabricated device that electrokinetically transports biological and chemical materials for applications such as, but not limited to, multiplexed DNA sequencing and drug screening. As used herein, electrokinetic forces means electroosmotic forces, electrophoretic forces, a combination of the two types of forces, any other forces that are generated by the application of a voltage differential across a medium that can support a field.

In one variation of the present invention, the microfabricated device comprises a plurality of channels fluidly connected to a detection chamber. The detection chamber is configured to provide multiple straight or confined sample flows therethrough. Consequently, detection of the samples in the detection chamber is enhanced as diffusion of the samples is minimized.

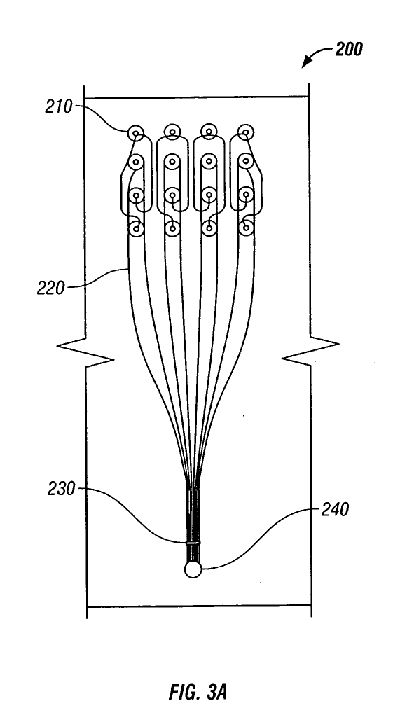

FIG. 3A is a top view of an exemplary microfabricated device 200 in accordance with the present invention. The device 200 includes a plurality of ingress reservoirs 210, a plurality of channels 220, a detection chamber 230, and a waste reservoir 240. In an application, samples and reagents are added to selected ingress reservoirs 210 and the added materials are electrokinetically manipulated to carry out various laboratory processes including mixing, separation, incubation, etc.

The channels 220 meet at the detection chamber 230 where detection is carried out by, for example, LIF. Finally, samples are electrokinetically transported downstream to the waste reservoir 240.

The microfabricated structure shown in FIG. 3A includes eight channel patterns. Each channel pattern includes a channel 220 and three ingress reservoirs 210. In this configuration, up to eight separate tests may be carried out in parallel. The present invention, however, is not so limited and includes any number of configurations depending on the application and the number of tests to be carried out in parallel. For example, a microfabricated device may feature 2-1000 parallel channels and more preferably 4 to 100 channels. Of course, the overall size of the chip must be adjusted to accommodate more channels. The overall dimensions for the fabricated structure can vary widely. Exemplary ranges for the thickness, width, and length are respectively 0.05 to 0.5 inches, 0.5 to 2.5 inches, and 1 to 10 inches.

An enlarged view of a reservoir in accordance with the present invention is shown in FIG. 3B. Reservoir 250 can be formed by bonding a cover or film having an aperture to a base or substrate. Typically, as discussed further below, the cover is bonded to the substrate such that the aperture(s) align over the channels or end segments of the channels. A suitable range for the diameter of the aperture is 0.5 to 15 mm but other diameters may be used. The reservoirs may also have a shape different than that shown in FIG. 3B. For example, the reservoir may be square, rectangular, oval, elongated, or have any other shape which is suitable for receiving fluid and or an electrode.

The reservoirs are useful for a number of reasons. First, samples and reagents may be conveniently added, introduced, and removed from the reservoirs. The reservoirs, in a sense, act as a means for supplying samples and materials to the micron-sized channels. For example, the tip of a syringe may be deployed at the reservoir to add a sample. Automated dispensing systems having multiple micro-tips may also be well suited for adding small volumes of materials to the reservoirs or wells.

The reservoirs also accept or receive electrodes. Electrodes are used to create electric fields and may be connected to a programmable voltage controller which applies a desired voltage differential between selected electrodes. The electrodes are positioned in the reservoirs such that electrical contact is made with a sample, material or medium therein. Suitable mediums include gels and fluids which are known to be useful in carrying out electrokinetic applications such as, but not limited to, sodium tetraborate and polyacrylamide gels. Suitable materials for the electrodes include platinum or other conducting materials.

Examples of controlling voltages in a microfluidic device are described in, for example, U.S. Pat. No. 6,010,607 which is hereby incorporated by reference in its entirety. All publications, patent applications, patents, and other references mentioned in this application are incorporated by reference in their entirety. To the extent there is a conflict between this application and another patent (or reference) incorporated by reference, this application will control.

The channels may likewise have various shapes and cross sections. Preferably, channels are enclosed and have smooth cross sections such that flow is uniform throughout the cross section of the channel. It is undesirable to have preferential flow along a comer of the channel.

Suitable cross-sections for the channels include rectangular and trapezoidal cross sections. However, other shapes are in accordance with the present invention. To some extent, the cross sectional shape of the channel is limited by known micro-machining and fabrication processes. A suitable range for the height of the channels is 0.1 to 100 um and a suitable range for the width of the channel is 0.1 to 100 um. However, it is to be understood that the channels may vary widely and other sizes are in accordance with the present invention.

Fabrication Techniques

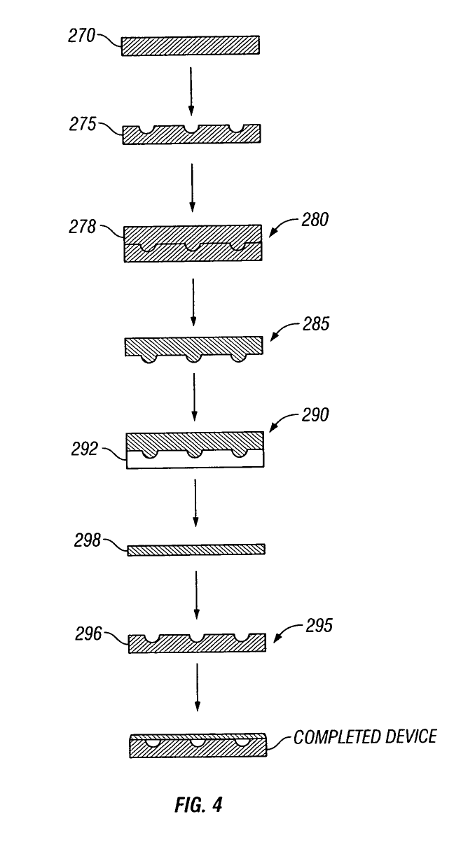

One method for fabricating microfluidic devices is illustrated in FIG. 4. As indicated in FIG. 4, a glass or silicon wafer 270 is masked and etched using typical wafer microfabrication processes. The etching step creates an etched glass plate 275 having, for example, a number of channels and chambers.

Next, a metal mold tool 278 is electroformed on the master wafer. This step is illustrated in FIG. 4 by reference numeral 280. As shown in steps 285 and 290, the metal mold tool is separated from the master wafer and plastic is molded or embossed using the metal mold tool.

Step 295 indicates a molded plastic part having a channel configuration identical to the pattern etched into the master glass wafer. The channel pattern of the plastic molded chip therefore can have micron-size channels identical to the master glass wafer.

Finally, a plastic cover or film is bonded or applied to the top of plastic substrate to enclose the channels as well as to provide the reservoirs as described above. Bonding is carried out by melting, fusing, annealing, application of adhesives, ultrasonic welding, or other controlled techniques to form a fluid tight seal with the channels. A preferred bonding technique is heating or fusing.

The substrate is preferably not electrically conducting. Further, coatings may be applied to achieve a desired flow affect or to prevent compounds from bonding to the substrate. Alternatively, the substrate may be conducting and include an insulative coating such that the electric field is directed substantially through the medium in the channels. Suitable materials for the substrate include glass and plastics. One preferable substrate material is Acrylic. Suitable materials for the cover include plastics such as Acrylic as well as films and tapes. Additionally, it is preferred that the substrate and cover are optically transparent and include no pigments or dyes.

The above fabrication process is provided as an example and is not intended to limit the present invention to a particular method of manufacture. For example, the molding/embossing step may be eliminated and the etched glass may be used as a substrate. However, it is preferred to build a metal tool and to mold/emboss plastic. Still other techniques such as that described in U.S. Pat. No. 6,010,607 may be used to fabricate microfluidic devices in accordance with the present invention.

Straightflow System

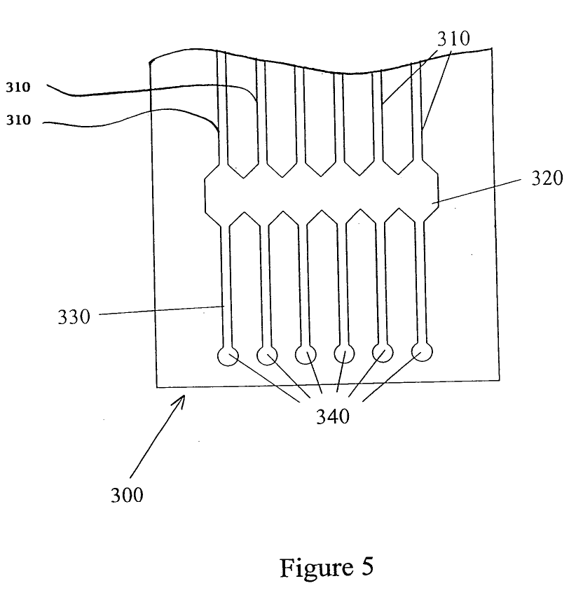

FIG. 5 is a top view of a portion of a device 300 in accordance with the present invention. FIG. 5 is not drawn to scale and has a number of dimensions exaggerated to more clearly illustrate certain features of the present invention.

Referring to FIG. 5, device 300 includes separation or input channels 310 which are fluidly connected to detection chamber 320. Downstream of the detection chamber are waste channels 330 which fluidly connect to waste reservoirs 340. In operation, for example, samples are separated in the input channels 310 using electrokinetic forces. Separated compounds or component materials thus enter the detection chamber sequentially and are individually detected by a detection process such as LIF. Concentration of the compounds may be determined from a detection process given the samples occupy a known volume. Measurements are accurate to the extent lateral diffusion (amongst other factors) are controlled in the detection chamber.

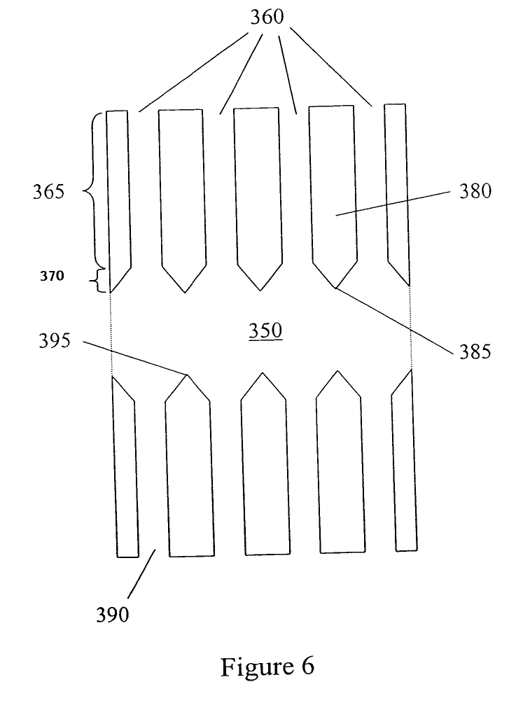

An enlarged top view of a detection chamber 350 in accordance with the present invention is shown in FIG. 6. In operation, samples and/or materials are electrokinetically driven through input channels 360 into detection chamber 350. The samples migrate in relatively straight confined streams (not shown) through the detection chamber and substantially no lateral diffusion occurs despite the absence of focusing sheathflows or side channel walls in the detection chamber.

The “channel-less” detection chamber 350 of the present invention is preferred over other systems because: (1) no sheathflow streams are necessary to confine the sample streams and consequently, the device and operation of the device are less complicated; (2) multiplexed detection, i.e. concurrent measurement or detection of multiple, parallel sample streams is enabled with the lateral introduction of a single beam across each stream; and (3) channels walls decrease performance of LIF detection systems because the walls may autofluorescence and/or interfere with excitation light propagating through the sample streams and in the detection chamber. Consequently, background is decreased and sensitivity is increased of the channels being measured.

The present invention overcomes the above noted shortcomings found in conventional devices by providing novel input channel and detection chamber configurations. In particular, each of input channels 360 comprises an intermediate section 365 and enlarged end section 370. The end section 370 shown in FIG. 6 is an outwardly expanding linear taper having a narrow end equal in width to the intermediate section and a wide end fluidly coupled to the detection chamber. The end section 370 of an input channel 360 may have other shapes including but not limited to curved tapers, parabolic tapers, step changes, and other shapes. Preferably, the end section gradually expands in width and has its maximum width at the detection chamber. A suitable width for the wide end of the end section 370 is between 10 and 2000 um and preferably between 100 to 300 um, and most preferably about 200 um. A suitable width of the narrow end of end section 370 is between 5 and 1000 um and preferably between 50 to 100 um and most preferably about 100 um.

It is also preferable to position input channels adjacent to one another as shown in FIG. 6. That is, each input channel is next to another input channel and a common wall 380 separates the adjacent input channels. Common wall 380 thus separates two adjacent input channels 360 and terminates at a point or tapered junction 385. Tapered ends or junctions 385 are shown terminating in a point but other shapes are possible depending on the shape of the end sections 365 of the input channels 370.

Downstream of input channels are a plurality of output channels 390. FIG. 6 shows output channels mirroring input channels 360. Output channels 390 thus define tapered junctions 395 having an identical shape to tapered junctions 385 on the input side.

Remarkably, we have found that the configuration shown in FIG. 6 provides straight and confined sample flows (not shown) through the detection chamber. Thus, accurate detection of samples can be carried out without interference from channel walls and without the added complexity of sheath or focusing flows. It was also observed that sample streams moving by electrokinetically motivated means maintained a “laminar” type flow around obstacles such as air bubbles encountered in the channel.

FIG. 7 is a variation of the detection chamber shown in FIG. 6. In particular, the detection chamber 400 of FIG. 7 comprises only one output channel 410. Output channel 410 includes an entrance section 420 and an intermediate section 430. The entrance section has a wide end fluidly connected with the detection chamber 400 and a narrow end fluidly connected to the intermediate section 430 of the output channel. In this variation, the entrance section is a linear taper with a gradual change in width. However, the entrance section can have other shapes such as parabolic, stepped, etc.

In operation, samples and/or materials are electrokinetically driven through the detection chamber 400 where they are measured. The sample streams move into the y-shaped output channel 410. Similar to the variation shown in FIG. 6, the samples or sample plugs migrate in relatively straight confined streams (not shown) through the detection chamber 400 and substantially no lateral diffusion occurs despite the absence of focusing sheathflows or side channel walls in the detection chamber.

The output channel need not be shaped as shown in FIGS. 6 and 7. The output channel, for example, may be substantially straight or have other shapes (not shown) that are not “Y-shaped.”

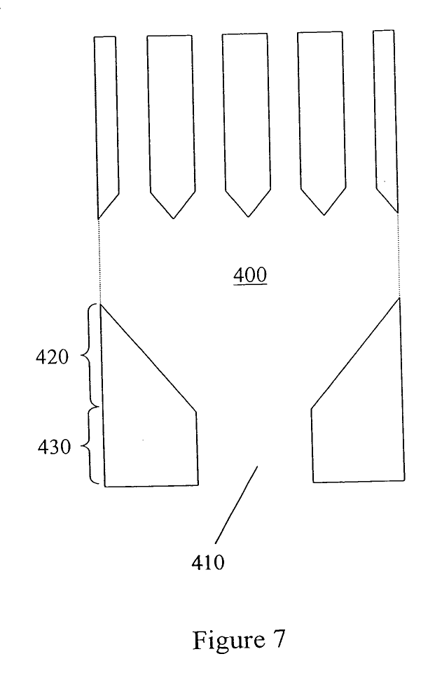

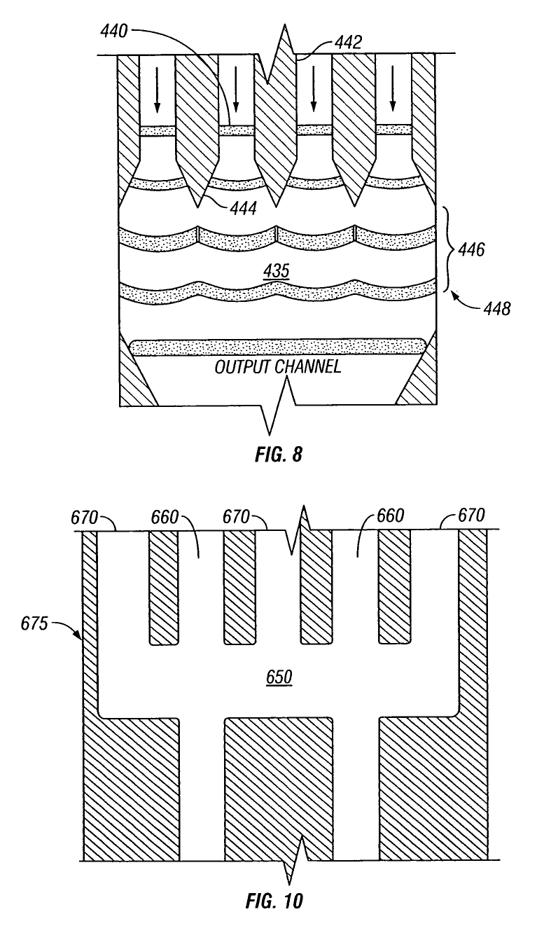

FIG. 8 shows a detection chamber 435 in an application. In this application, a sample is delivered as a sample plug 440 and is shown progressing downstream through the input channel 442. Sample plug 440 may be, for example, an electrophoretically separated component or compound of a larger sample.

Sample plug 440 widens as it moves through enlarged end section 444 and becomes yet wider as it enters detection chamber 435. Notably, sample plug 440 enters detection chamber 435 as a discrete plug and remains substantially discrete while moving through the detection zone 446. Sample plug 440 does not begin to significantly mix or laterally diffuse until it reaches a threshold location 448. Accordingly, individual sample plugs (or in the case of steady-state flow, sample streams) can be accurately measured while in the detection zone 446 of detection chamber 435 because substantially no diffusion occurs in this region. The threshold distance or location typically ranges from 10 to 2000 microns, and more typically 100 to 1000 microns depending on characteristics of the microfabricated structure including but not limited to the shape and sizes of the end sections, the tapered junctions, the electric fields supplied to mediums, and other features known in light of this disclosure that affect lateral diffusion of the samples as they migrate through the detection chamber.

Ancillary-flow Systems

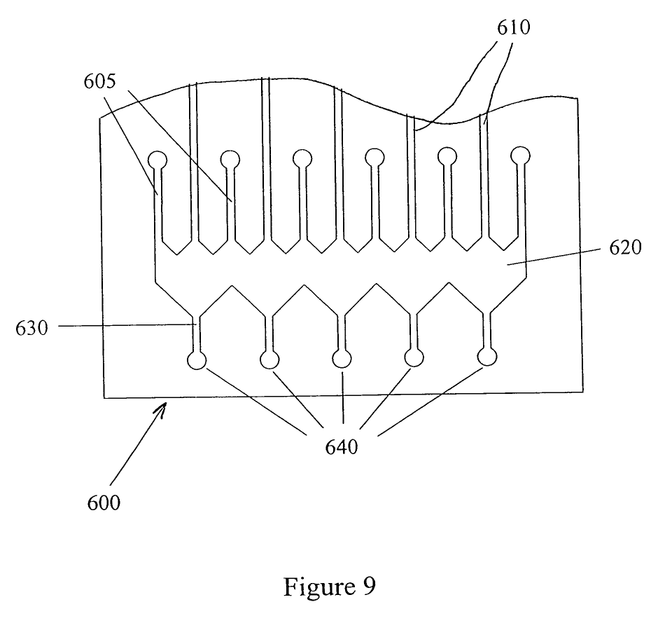

FIG. 9 is a top view of a portion of a device 600 in accordance with the present invention having ancillary flow channels 605. The illustration shown in FIG. 9 is not to scale. Device 600 also includes separation or input channels 610 which are fluidly connected to detection chamber 620. Downstream of the detection chamber are waste channels 630 which fluidly connect to waste reservoirs 640.

In operation, samples are separated in the input channels 610 using electrokinetic forces. Separated compounds or component materials enter the detection chamber sequentially and are individually detected by a detection process such as LIF. Electric fields are also applied to the ancillary flow channels 605 such that the sample streams from the separation channels are pinched and or confined as they move through the detection chamber. Plugs of sample will thus occupy a repeatable (and known) volume because lateral diffusion are prevented by the ancillary flow fluids and/or the electric fields focusing the sample streams.

A manifold having a detection chamber 650 in accordance with the present invention is shown in FIG. 10. The manifold is preferably a portion of a monolithic device having a number of other features such as channels and reservoirs. Preferably, the manifold is integral with the device.

In operation, samples and/or materials are electrokinetically driven through input channels 660 into detection chamber 650. The samples migrate through the detection chamber and substantially no lateral diffusion occurs due to the presence of outer electrokinetic transport from the ancillary flow channels 670. The sample streams or plugs do not mix until downstream of the detection point 675.

The manifold shown in FIG. 10 does not feature input channels having enlarged end sections. The manifold shown in FIG. 10 also lacks tapered junctions. However, it is to be understood that such features may be incorporated into (or combined with) the manifold shown in FIG. 10.

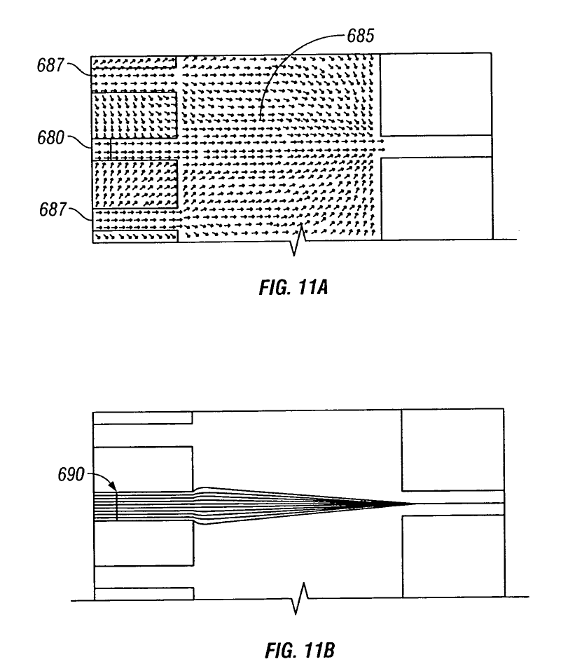

The confining or focusing effect is caused by a number of factors including the electric fields applied to the system. FIG. 11A illustrates an electric field pattern for a model structure. As shown in FIG. 11A, relatively straight electric field lines commence at separation or input channels 680 and continue straight through the detection chamber 685. In contrast, the electric field lines of the ancillary flow channels 687 have curved trajectories and push or confine the sample stream.

FIG. 11B illustrates the streamline trajectories for massless particles released at segment 690. According to our computer generated model, the massless particles are shown laterally confined in the detection chamber. The sample stream in fact narrows. Accordingly, detection can be carried out on the samples with minimum or no lateral dispersion of the individual sample streams. For the illustrations shown in FIGS. 11A and 11B, the following assumptions were made: (1) electrophoretic transport was assumed through the entire structure; (2) salt water filled the channels; and (3) the substrate material was nylon.

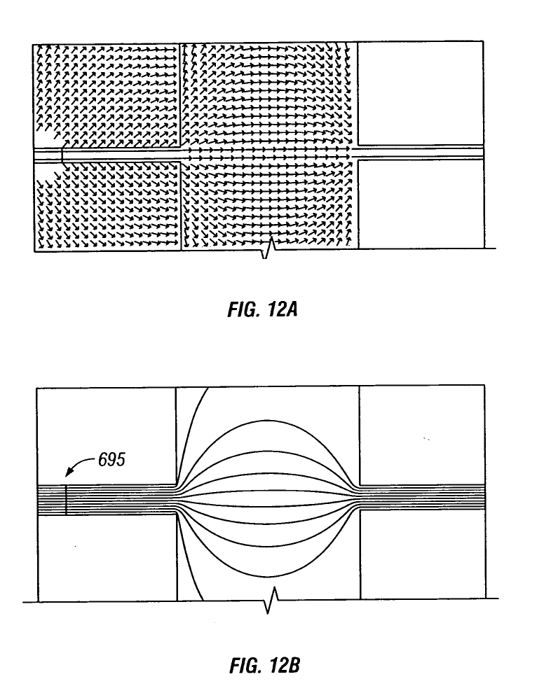

For comparison, FIGS. 12A and 12B show a detection chamber without all the features of the present invention. In particular, the manifolds shown in FIGS. 12A and 12B lack tapers and lack ancillary flow channels. FIG. 12A shows electric field patterns for a single separation channel in fluid connection with a detection chamber. The electric field patterns “balloon” as they reach the detection chamber. FIG. 12B shows the streamline trajectories of massless particles released at segment 695. Clearly, the plug of sample disperses as it enters the detection chamber. This is highly undesirable because, as stated above, the sample becomes diluted.

Additional Variations

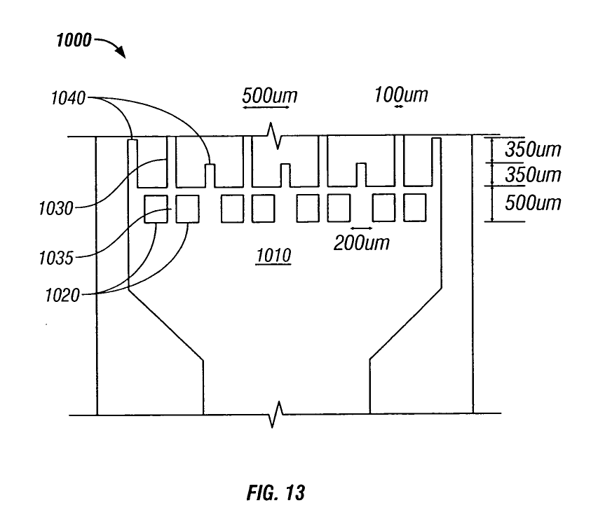

FIG. 13 is a top view of a portion of another device 1000 in accordance with the present invention. The microfabricated device 1000 shown in FIG. 13 features a detection chamber 1010 having a plurality of channel supports 1020. Input channels 1030 supply sample plugs or sample streams into the detection chamber. Amongst other things, the channel supports 1020 prevent bowing of the cover into the detection chamber 1010. The sample streams remain substantially straight and confined and as they move into the space 1035 between adjacent channel supports 1020.

The channel supports prevent a cover bonded to the device from bowing across the detection chamber. The channel supports also aid in confinement of the sample streams or plugs as they move through the detection chamber.

Additionally, ancillary flow streams may be supplied from ancillary flow channels 1040 to further confine sample streams as they electrokinetically migrate through the detection chamber. Preferably, samples are measured downstream of the input channels 1030 and upstream of the channel supports 1020. Channel supports may be positioned opposite, across, or across and offset from the tapered junctions (not shown).

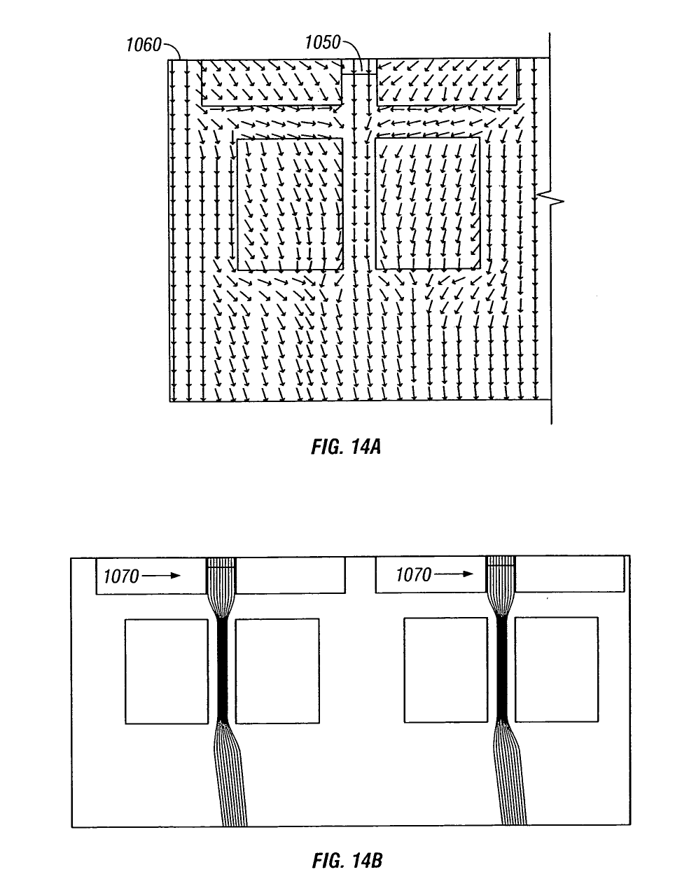

FIGS. 14A and 14B are illustrations of the static electric field patterns and streamline trajectories for massless particles released at the indicated line respectively in a microfabricated device as shown in FIG. 13. Referring to FIG. 14A, the separation or input channel 1050 has relatively straight electric field lines through the detection chamber. In contrast, the ancillary flow channels 1060 have curved trajectories and push or confine the sample stream.

FIG. 14B illustrates the streamline trajectories for massless particles released at segments 1070. According to our computer generated model, these massless particles will have minimal lateral dispersion through the detection chamber. The sample stream in fact narrows. Accordingly, detection can be carried out on the samples with minimum or no lateral dispersion of the individual sample streams.

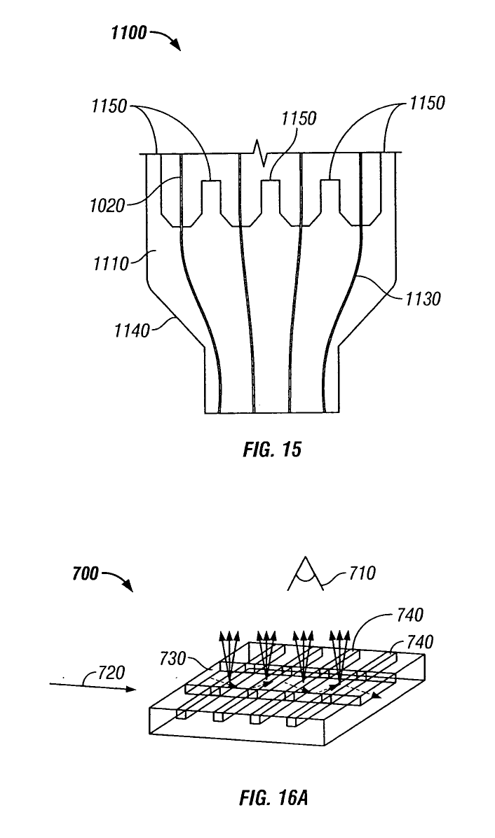

FIG. 15 is a top view of another embodiment in accordance with the present invention. The illustration in FIG. 15 shows the trajectories of sample streams flowing through a detection chamber 1110 of device 1100. The device 1100 includes input channels 1120 which supply sample plugs or sample streams into the detection chamber. The sample streams 1130 do not substantially diffuse in the lateral direction as they move through the detection chamber and into an output channel 1140.

Additionally, ancillary flow streams (not shown) are supplied from ancillary flow channels 1150 to further confine sample streams as they electrokinetically migrate through the detection chamber. Samples are measured downstream of the input channels 1150.

Unlike the above discussed variations of the present invention, the variation shown in FIG. 15 features taperless input channels and its ancillary flow channels include outward tapers. The variation in FIG. 15 thus illustrates the flexibility of the present invention and the wide combinations of features which may be incorporated into a microfluidic device.

Detection Setup

Samples and components of the samples may be measured or detected various ways including, for example, laser induced fluorescence (LIF). LIF is preferred because of the high sensitivities achievable using fluorescence. Typically, a signal is received by exciting a fluorescent label or marker in the sample stream with an excitation beam such as a laser. Rhodamine and fluorescein dyes are suitable labels but other labels may used depending on the experiment protocol.

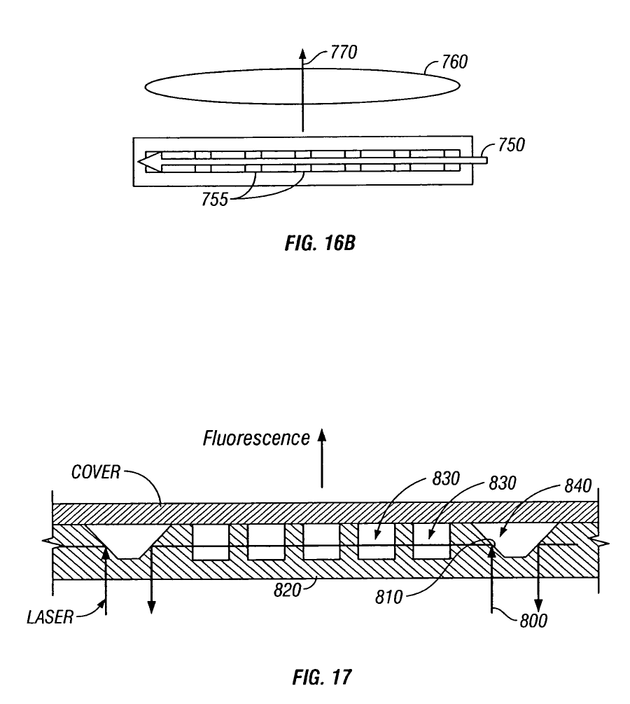

Unlike conventional detection systems employing LIF, the present invention provides a beam directed in the plane of the device and perpendicular to the sample streams as shown in FIGS. 16A and 16B. This optical configuration generates less autofluorescence and receives less background signals from the chip substrate than by conventional detection techniques wherein the excitation beam is normal to the device plane.

Referring to FIG. 16A, an illustration of a detection setup 700 in accordance with the present invention is shown. The Detection setup 700 shown in FIG. 16A includes a detector (including a lens, etc.) 710 normal to the plane of the device and a laser beam 720 directed through the detection chamber 730 in the plane of the device. The detector, however, need not be normal to the device. FIG. 16A further depicts the beam propagating substantially perpendicularly through the individual sample streams 740 as it transverses the detection chamber.

An enlarged cross-sectional view of a detection setup is shown in FIG. 16B. Referring to FIG. 16B, a laser beam 750 is shown directed in the plane of the device and propagating across the detection chamber. The beam 750 perpendicularly intersects each of the sample streams 755 as it transverse the detection chamber. A lens 760 is shown positioned above the device measuring emitted light 770. While not shown, individual detectors may be positioned above the device such that at least one detector measures the signal from each detection region or zone within the detection chamber.

The detection system should also be designed such that the cover plate (or film) and bottom of the channel do not interfere with the beam. The detection chamber depth, width, and laser beam diameter at focus will influence where along the width of the detection chamber the upper and lower surfaces of the detection chamber will interfere with the outer fringes of the expanding laser beam. A suitable width for the detection chamber is, for example, between 100 um and 10 mm and preferably about 1.6 mm (8 separation channels, each 200 u wide). A suitable depth for the detection chamber is between 10 and 250 um.

The expansion of a laser beam depends on the diameter at focus, the wavelength, and the refractive index of the medium. Other optical beams expand more than a laser and therefore are less preferred.

Another technique to direct an excitation beam across the sample streams in the plane of the device is illustrated in FIG. 17. In particular, a laser beam 800 is directed at an angled reflector 810 which reflects the laser beam across sample channels 830 in the plane of the device. The excitation beam perpendicularly intersects each of the sample channels 830 as the beam transverses the device.

The reflector 810 may be in the form of a reflection channel 840 having angled walls as shown in FIG. 17. The reflection channels may have reflective metal coatings to provide reflection of the laser. Suitable metal coatings include but are not limited to aluminum. Such coatings may be sputtered on or deposited on the channel by other known microfabrication techniques. The reflection channels may be evacuated or contain, for example, air.

A suitable angle for the angled walls is 30 to 50 degrees and preferably, 45 degrees. A 45 degree angled wall, for example, allows an excitation source to be positioned normal to plane of the device yet still propagate the laser beam across the channels 830 in the plane of the device. Thus, only one excitation beam is necessary to excite each of the sample channels or streams 830.

While FIG. 17 shows five independent channels, the invention is not so limited. The device may include more or less channels. For example, a single channel or detection chamber may be provided in which multiple sample streams are directed therethrough. The sample streams may be prevented from substantially diffusing or mixing as set forth in the above described embodiments. In order to excite the samples for LIF detection, a light beam may be directed at a reflector such that the light reflects off the reflector towards the detection channel. While the light propagates through the detection channel it perpendicularly crosses each sample stream thereby exciting light-responsive or fluorescing materials in the streams.

Variations on this approach can be utilized to alleviate defects or imperfections that may be present in the microfluidic device that would interfere with transmission or propagation of the excitation source. Devices incorporating such defects can result from current limitations inherent in conventional molding and microfabrication techniques. These problems are further aggravated given the scale and detail required for optical quality microfeatures such as the reflecting and detection channels described herein. For example, in a sealed microfluidic device that has been conventionally molded the interface between the walls of the fluidic channels and the cover may not be sharp or distinct resulting in poor optical transmission properties. Furthermore, in a reflecting microfeature or side launch channel that has been conventionally fabricated or molded optical defects can occur at the terminal ends of the feature leaving the center of the reflecting surface as the only functional region. Accordingly, it is desirable to direct and transmit the excitation source using the regions of the optical microfeatures where molding defects and fabrication imperfections may be absent or less prevalent.

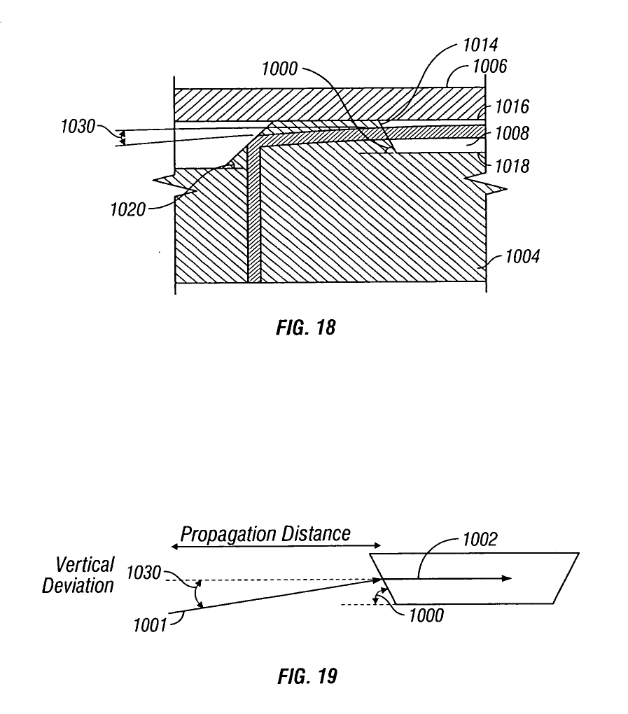

As shown in FIGS. 18 and 19, this can be accomplished by controlling (or compensating for) draft angle 1000 that is fabricated in a device. The draft angle 1000 of channel 1008 is the angle side wall 1014 makes with a plane 1016 or channel floor 1018. Using variables such as excitation source, relevant indices of refraction, entry or incidence angle 1030, and materials contained in and comprising the device, one skilled in the art can tailor the effectiveness with which the excitation source will be directed through the device for purposes of LIF and other relevant detection methods. For example, given a draft angle, a device may be designed having a certain entry angle which optimally directs a light beam through the detection chamber.

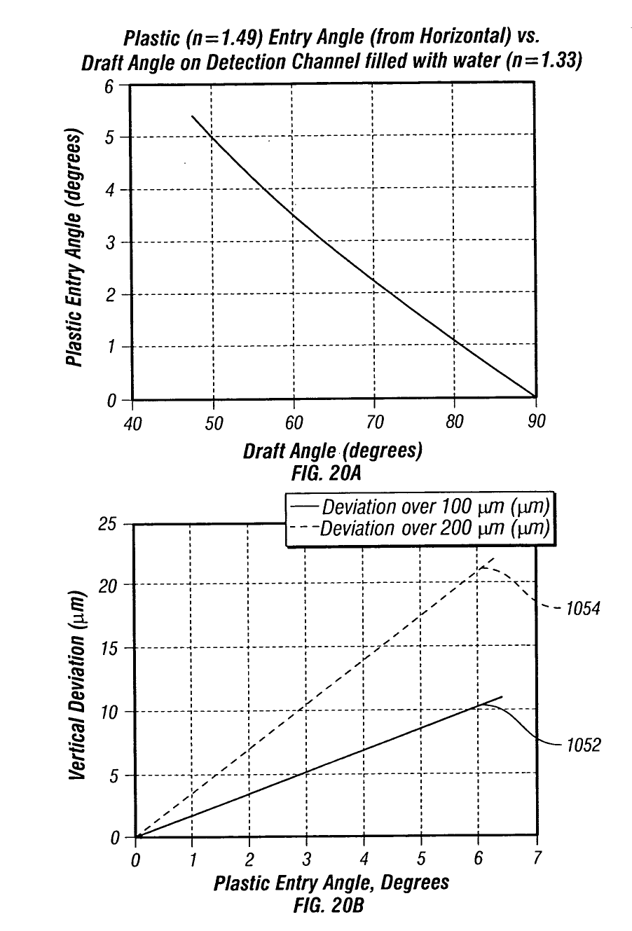

FIGS. 20A and 20B illustrate the relationship between various parameters which can be manipulated to control optical detection properties in a microfluidic device that integrates side launch microfeatures as described herein. In particular, FIG. 20A indicates entry angle 1030 for a given draft angle 1000 to result in a horizontal light beam 1002. For the given indices of refraction, FIG. 20A shows that the entry angle varies from about 1-5 degrees for draft angles of about 80 to 50 degrees respectively. Further, for a draft angle of about 70 degrees, the entry angle is between 2 to 3 degrees.

FIG. 20B indicates vertical deviation for a given entry angle 1030 and propagation distance. In FIG. 20B, reference numerals 1052 and 1054 correspond to propagation distances 100 microns and 200 microns respectively.

All of the features disclosed in the specification (including any accompanying claims, abstract and drawings), and/or all of the steps of any method or process disclosed, may be combined in any combination, except combinations where at least some of such features and/or steps are mutually exclusive.

Each feature disclosed, in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1. A microfabricated device for electrokinetically moving samples comprising:
a detection chamber for receiving a plurality of adjacent sample streams to be detected;
a plurality of adjacent input channels fluidly connected to said detection chamber, each of said plurality of input channels fluidly connected to said detection chamber via an enlarged end section; and
at least one output channel fluidly connected to said detection chamber.

2. The device of claim 1 wherein said end section varies in width as function of distance from the detection chamber, said end section being widest at said detection chamber.

3. The device of claim 2 wherein said end section has a gradual taper.

4. The device of claim 3 wherein said taper is linear.

5. The device of claim 3 wherein said taper is parabolic.

6. The device of claim 4 wherein adjacent input channels are separated by a tapered junction.

7. The device of claim 6 wherein said detection chamber further comprises a plurality of adjacent channel supports, said channel supports positioned opposite of said tapered junctions and useful in minimizing sample diffusion when electrical fields are applied to said device to electrokinetically move sample materials.

8. The device of claim 3 having only one y-shaped output channel positioned opposite of said plurality of input channels.

9. The device of claim 3 further comprising a number of output channels equal to said input channels and said output channels being positioned opposite of said input channels.

10. The device of claim 9 wherein said output channels are configured as mirror images of said input channels.

11. The device of claim 1 wherein said plurality of adjacent sample streams remain discrete for at least a threshold distance through the detection chamber, said threshold distance being between 10 to 2000 um.

12. A microfabricated manifold for use in electrokinetic applications comprising:
a detection chamber;
a plurality of adjacent channel inlets fluidly connected to said detection chamber; and
a plurality of tapered ends wherein adjacent channel inlets are separated by a tapered end.

13. The microfabricated manifold of claim 12 wherein each channel inlet comprises a first end section and a second wider end section downstream of said first end section.

14. The microfabricated manifold of claim 13 wherein each channel inlet is taper-shaped.

15. The microfabricated manifold of claim 14 wherein said taper is linear.

16. The microfabricated manifold of claim 14 wherein said taper is parabolic.

17. The microfabricated manifold of claim 12 further comprising at least one y-shaped outlet.

18. The microfabricated manifold of claim 12 further comprising a channel outlet positioned opposite each of said channel inlets.

19. The microfabricated manifold of claim 12 wherein said detection chamber further comprises a plurality of channel supports, said channel supports positioned opposite of said tapered ends such that a sample stream exiting said channel inlet flows between two channels supports and does not diffuse in the lateral direction.

20. A method for multiplexed detection of samples in a microfluidic device, said method comprising the steps of:
introducing a sample into at least two of said plurality of input channels of the device of any one of claims 1-11;
applying electrical fields to said device such that said samples flow as discrete sample streams from said plurality of input channels into said detection chamber; and
detecting a property of said sample streams while said sample streams flow through said detection chamber.

21. A method for multiplexed detection of samples in a microfluidic device, said method comprising the steps of:
electrokinetically flowing at least two sample streams into a detection chamber, said at least two sample streams defining a device plane;
directing a light beam through said detection chamber such that said light beam perpendicularly intersects said at least two sample streams and propagates in said device plane; and
detecting an optical property of said at least two sample streams as said streams flow through said detection chamber.

22. The method of claim 21 wherein said device further comprises tapered junctions extending into said detection chamber and useful in preventing said sample streams from laterally dispersing.

23. The method of claim 22 wherein said sample streams remain straight as said sample streams flow through said detection chamber.

24. The method of claim 21 further comprising electrokinetically flowing ancillary flows around said sample streams such that lateral dispersion is prevented.

25. The method of claim 21 wherein said light beam is a laser.

26. The method of claim 21 wherein said device further comprises a reflector for reflecting the light beam through the sample streams.

27. The method of claim 26 wherein the reflector is at a 45 degree angle.

28. The method of claim 26 wherein the light source is not normal to the plane of the device.

29. The method of claim 26 wherein the light beam is directed from a light source not in the plane of the device.

30. The method of claim 21 wherein the light beam is directed from a light source in the plane of the device.

31. A microfluidic system for carrying out various chemical and biochemical processes, said system comprising:
a microfabricated device having a detection chamber and a plurality of input channels, said input channels and detection chamber defining a plane of the device;
a controller adapted to provide electric fields such that when samples are present in said input channels, said samples can be electrokinetically manipulated through said input channels and into said detection chamber by application of said electric fields;
a light source adapted to direct a light beam across said detection chamber and in the plane of the device, said beam perpendicularly intersecting said samples when said samples flow through said detection chamber; and
at least one detector for measuring optical properties of said samples in said detection chamber wherein sample streams introduced into said detection chamber are detected simultaneously.

32. The system of claim 31 wherein said microfabricated device is a device as recited in any one of claims 1-11.

33. The system of claim 31 further comprising ancillary flow channels interposed between said input channels such that confining streams from said ancillary flow channels confine sample streams entering the detection chamber such that lateral diffusion is minimized.

34. The system of claim 31 wherein said input channels are separation channels and contain a medium useful in electrophoretic separations.

35. The system of claim 31 wherein at least one of said input channels is shaped as an input channel of FIG. 6.

36. The system of claim 31 wherein at least one of said input channels is shaped as an input channel of FIG. 7.

37. The method of claim 22 wherein said sample streams curve as said sample streams flow through said detection chamber.

38. The device of claim 6 wherein the tapered junction terminates at a point.

39. The device of claim 6 wherein the tapered junction has a blunt tip.

40. A microfabricated device for electrokinetically moving samples comprising a detection chamber as shown in FIG. 15.

41. The microfluidic system of claim 31 wherein said detection chamber includes a side wall having a draft angle less than 90 degrees.

42. The microfluidic system of claim 41 wherein said draft angle is 70 degrees.

43. The method of claim 21 wherein said detection chamber includes a side wall having a draft angle less than 90 degrees.

44. The method of claim 43 wherein said draft angle is 70 degrees.

45. The method of claim 43 further comprising the step of directing the beam at said side wall at an entry angle not equal to zero.

46. The method of claim 45 wherein the entry angle is between 1 and 5 degrees.

47. The method of claim 46 wherein the entry angle is between 2 and 3 degrees.
